(19) United States
(12) Patent Application Publication
(10) Pub. No.: US 2025/0135719 A1
(43) Pub. Date: May 1, 2025

(54) Lift-Based Peel Separation for Inverted Vat Photopolymerization 3D Printing

(71) Applicant: University of Cincinnati, Cincinnati, OH (US)

(72) Inventors: Prashant Ravi, Cincinnati, OH (US); Vishnushankar Viraliyur Ramasamy, Cleveland, OH (US)

(73) Assignee: University of Cincinnati, Cincinnati, OH (US)

(21) Appl. No.: 18/834,776

(22) PCT Filed: Jan. 31, 2023
(86) PCT No.: PCT/US23/11928

§ 371 Date: Jul. 31, 2024

Related U.S. Application Data
(60) Provisional application No. 63/304,981, filed on Jan. 31, 2022.
(60) Provisional application No. 63/402,989, filed on Sep. 1, 2022.

(51) Int. Cl. B29C 64/245; B29C 64/124; B33Y 10/00; B33Y 30/00

(52) U.S. Cl. CPC B29C 64/245; B29C 64/124; B33Y 10/00; B33Y 30/00

(57) ABSTRACT

A method of inverted SLA 3D printing with a printing device is disclosed. The method involves a) lifting a thin elastic membrane to an elevated position within a resin filled vat via vertical movement of an optical module, the resin filled vat, or both. b) allowing resin on the thin elastic membrane to cure as a current layer, the layer being attached to a printed part, and c) peeling the thin elastic membrane from the current layer by lowering the optical module, raising the resin filled vat, or both.

### CROSS-REFERENCE TO RELATED APPLICATIONS

This application is a continuation of PCT Application No. PCT/US23/11928 filed Jan. 31, 2023, which claims the benefit of the filing date of U.S. Provisional Application No. 63/304,981 filed Jan. 31, 2022, and U.S. Provisional Application No. 63/402,989 filed Sep. 1, 2022, the disclosures of which are incorporated by reference herein in their entirety.

### FIELD OF THE INVENTION

This invention relates generally to inverted vat photopolymerization (VP) and stereolithography (SLA) 3D printing.

### BACKGROUND OF THE INVENTION

Currently, products made using inverted SLA or VP 3D printing can have issues regarding the quality of the printed product, the efficiency of the printing, and print speed. Quality is related to the layer height, pixel size/laser spot, energy dosage, and the amount of deformation experienced by any part during the 3D printing process. Several other factors also affect quality, but the ones mentioned above are the most significant. By lowering the peel forces, the quality of the printed part could be drastically improved. Also, softer materials or materials with higher adhesion can be better 3D printed if they experience lower deformation forces. Furthermore, the lower generated deformation forces would be expected to result in a reduced incidence of print failure and hence improved efficiency (success rate) of the parts. Print speed is based on many factors, but the most important contributors are layer exposure time and peel time because these processes are part of every printed layer, and a part can have thousands of layers depending on the size and layer thickness.

Peel time can consume 50-75% of the total print time per layer. As imaginable, this slows down the process considerably. Prior attempts to improve the print speed include reducing exposure time by using a higher-powered water-cooled light source or reducing peel force and peel time by coating the membrane with a non-stick material. In addition, efforts have been made to improve the inverted SLA peel process, including lifting a tiny region of the elastic membrane only via horizontal movement of the optical module, flexure of the vat container to induce separation of the part, and oxygen diffusion to create a dead zone for continuous printing. However, each of these approaches has its own set of limitations. Therefore, a need still exists for methods to improve quality, printing efficiency, and print speed for SLA and VP 3D printers without the need to deal with the set of limitations such as those caused by other approaches.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

One aspect of the present invention is directed to a method of inverted SLA 3D printing with a printing device. The device includes a build platform; a printed part; a current layer; a thin elastic membrane; a resin filled vat, wherein the resin has a surface with a horizontal plane; and an optical module including a rounded top. The thin elastic membrane forms at least a portion of the bottom of the resin filled vat and the optical module is located below the resin filled vat. The method involves:
A. lifting the thin elastic membrane to an elevated position within the resin filled vat via vertical movement of the optical module, the resin filled vat, or both,
B. allowing resin on the thin elastic membrane to cure as a current layer, said layer being attached to the printed part, and
C. peeling the thin elastic membrane from the current layer by lowering the optical module, raising the resin filled vat, or both.

In one embodiment, the angle of the thin elastic membrane when it is peeled from the current layer is higher than the industry standard peel. In another embodiment, the angle of the thin elastic membrane when it is peeled from the current layer is greater than about 5 degrees from the horizontal plane. In one embodiment, the angle of the thin elastic membrane when it is peeled from the current layer is greater than about 10 degrees from the horizontal plane. In one embodiment, the angle of the thin elastic membrane when it is peeled from the current layer is about 15 to about 25 degrees from the horizontal plane. In another embodiment, the thin elastic membrane comprises a non-stick material. In one embodiment, the optical module has a top surface with rounded corners and edges. In one embodiment, the rounded top of the optical module is a separate structure having a top surface with rounded corners and edges that can be attached to the optical module. In another embodiment, the thin elastic membrane is lifted to an elevated position within the resin filled vat via vertical movement of the optical module. In one embodiment, the thin elastic membrane is lifted to an elevated position within the resin filled vat via vertical movement of the resin filled vat.

In another aspect of the present invention, an inverted SLA 3D printing device is disclosed. The device includes a build platform; a thin elastic membrane; a resin filled vat, wherein the resin has a surface with a horizontal plane; and an optical module including a rounded top. The thin elastic membrane forms at least a portion of the bottom of the resin filled vat. The optical module is located below the resin filled vat. Further, the thin elastic membrane can be raised to an elevated position within the resin filled vat via vertical movement of the optical module, the resin filled vat, or both. In addition, the thin elastic membrane can then be lowered, returning the thin elastic membrane to a non-tensioned state.

In one embodiment, the thin elastic membrane comprises a non-stick material. In another embodiment, the optical module has a top surface with rounded corners and edges. In one embodiment, the rounded top of the optical module is a separate structure having a top surface with rounded corners and edges that can be attached to the optical module. In one embodiment, the thin elastic membrane can be lifted to an elevated position within the resin filled vat via vertical movement of the optical module. In another embodiment, the thin elastic membrane can be lifted to an elevated position within the resin filled vat via vertical movement of the resin filled vat.

### BRIEF DESCRIPTION OF THE DRAWINGS

The objects and advantages of the disclosed invention will be further appreciated in light of the following detailed descriptions and drawings in which:

FIGS. 1A-1D are schematics showing a prior art (industry standard) peel process. FIG. 1A shows the initial position of the 3D printing device. FIG. 1B shows the build platform and cured part lowered into the resin vat. FIG. 1C shows the build platform and cured part being raised from the vat. FIG. 1D shows the build platform and cured part returning to their initial positions.

FIGS. 2A-2D are schematics showing an embodiment of a lift-based peel process according to the present invention. FIG. 2A shows the initial position of the 3D printing device. FIG. 2B shows the build platform and cured part lowered into the resin vat while the optical module is raised from below. FIG. 2C shows the build platform and cured part being raised from the vat. FIG. 2D shows the build platform, cured part and optical module returning to their initial positions.

FIGS. 3A-3D are schematics showing a second embodiment of a lift-based peel process according to the present invention. FIG. 3A shows the build platform and cured part being lowered as well as the resin vat onto the optical module located below. FIG. 3B shows a new cured layer being formed. FIG. 3C shows the build platform, cured part and vat being raised. FIG. 3D shows the build platform, cured part and vat returning to their initial positions.

FIG. 4 is a photograph of a commercial desktop inverted SLA 3D printer with custom design modifications.

FIG. 5 is a photograph showing a comparison of a vat with and without the shoulder element for the optical module.

FIG. 6 is a photograph of a vat with the optical module at the bottom enabled.

FIG. 7 is a graph showing a plot of the lift-based peel temporal force data from an embodiment of the present invention showing a peak of 3.77N for a 40 mm width×40 mm breadth×1 mm height cuboidal layer. The units are Newtons on the Y-axis and Seconds on the X-axis.

FIG. 8 is a graph showing a plot of the peel temporal force data for an industry standard process showing a peak of 12.52N for a 40 mm width×40 mm breadth×1 mm height cuboidal layer. The units are Newtons on the Y-axis and Seconds on the X-axis.

FIG. 9 is drawing of a CAD model of one embodiment of the prototype 3D printer with the novel lift-based peel moving vat technique incorporated.

FIG. 10 is a drawing of a magnified CAD model of the shoulder.

### DETAILED DESCRIPTION OF THE INVENTION

The present invention discloses various techniques to reduce peel force including altering the shape of the non-stick membrane by 1) vertical movement of the optical module or 2) vertical movement of the vat to lift the full build area at once. Either of these approaches can reduce peel forces and improve the peel separation process. The techniques of the present invention can unlock many benefits not afforded by other prior art techniques. For instance, other techniques that rely on a lubricant coating or oxygen diffusion necessitate increased consumption of consumables (vat membrane) or require highly porous geometries to work effectively due to the limitation of resin flow and heat dissipation of the exothermic VP process. Additionally, the techniques of the present invention produce higher peel angles which reduces energy dissipation in the form of frictional sliding which dominate at lower peel angles. Finally, the net forces generated in the membrane and consequently on the part can potentially be lower. This can imply higher quality of the printed components due to the low deformation forces experienced, as well as a higher lifespan for the consumable non-stick membrane over the life cycle of the printer into which this novel lift-based peel described herein is incorporated.

The present invention involves a method to improve quality (lower deformation forces), efficiency (reduce failure rate) and print speed (throughput) in inverted stereolithography 3D printing. Quality is related to the layer height, pixel size/laser spot and amount of deformation experienced by the part during 3D printing. Several other factors also affect quality, but the aforementioned are significant. By lowering the peel forces, quality can be improved. Softer materials or materials with higher adhesion could be 3D printed due to the lower deformation forces. Furthermore, the lower generated deformation forces would be expected to result in reduced print failures and hence improved efficiency (success rate) of the parts. Print speed is based on many factors, but the most important contributors are layer exposure time, peel (lift) time and lowering time because these processes are part of every printed layer, and a part can have thousands of layers depending on the size and layer thickness. Peel time can sometimes consume 50-75% of the total print time per layer. As imaginable, this slows down the process considerably. There have been previous attempts to improve print speed such as reducing exposure time by using a higher-powered water-cooled light source or reducing peel force and time by coating the membrane with a non-stick material. Another attempt involved lifting a tiny region of the elastic membrane but only via horizontal movement of the optical module. However, the present invention takes a novel approach by seeking to substantially increase the peel angle by vertical movement of the optical module and/or vat to lift the full build area at once in an effort to reduce peel forces.

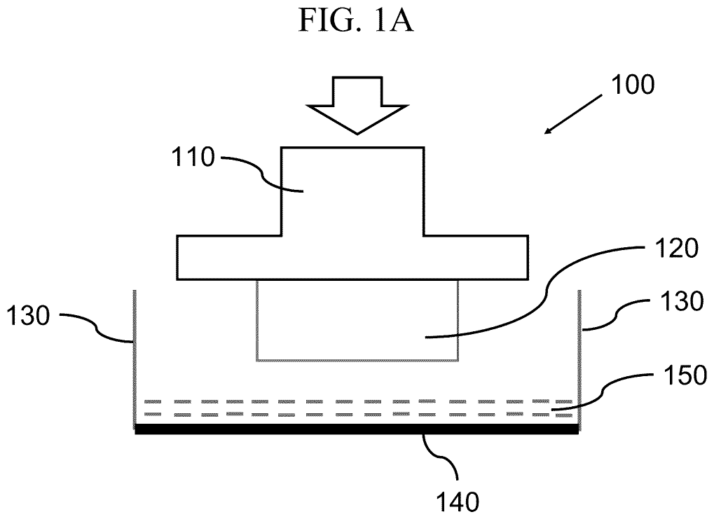

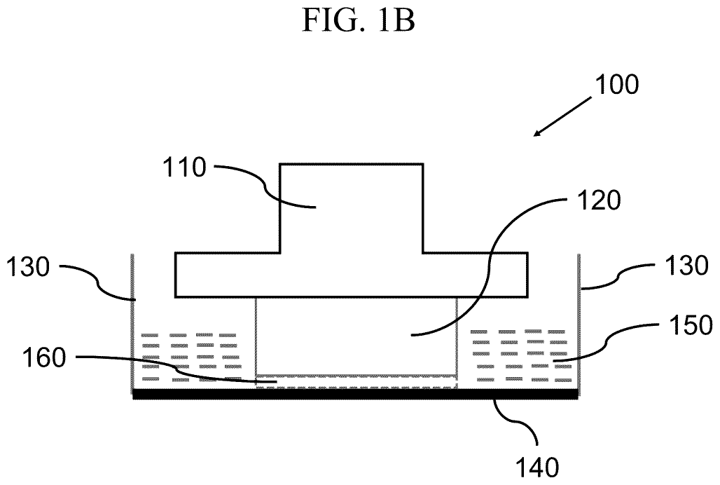

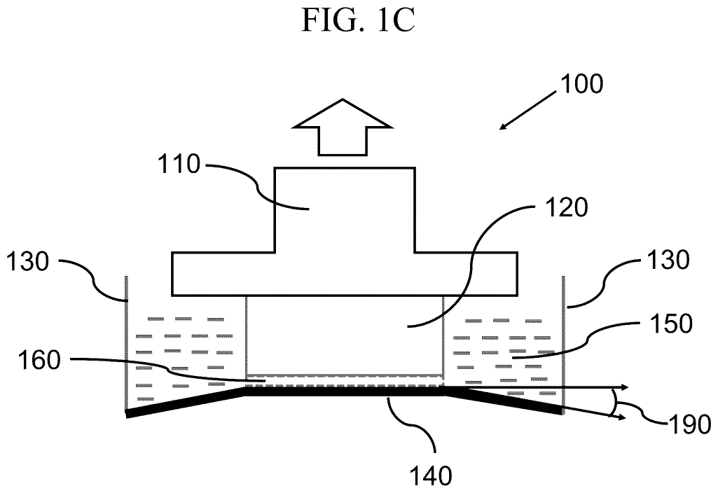

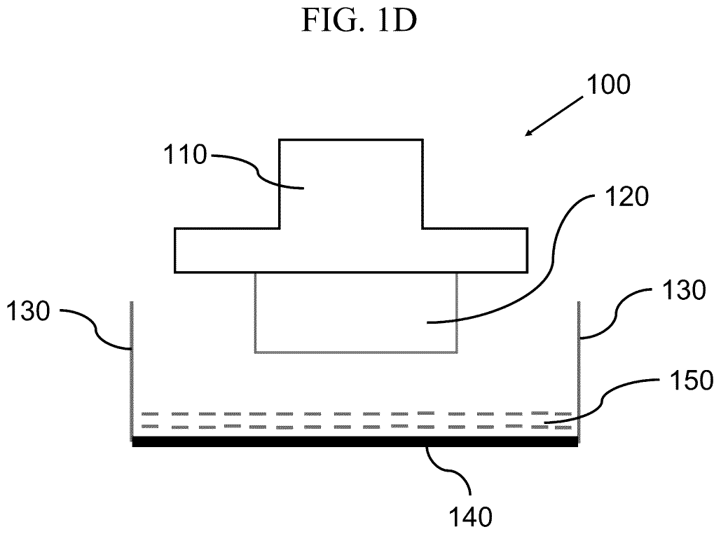

A schematic of the industry standard peel process is shown in FIGS. 1A-1D, where like numerals refer to like features. A peel-based 3D printing device 100 is shown. The device has a thin elastic membrane 140 at the bottom of a vat 130. There is resin 150 in the vat 130. A cured part 120 is attached to a build plate 110. Referring to FIG. 1A, as indicated by the arrow, the build plate 110 is lowered into the resin filled vat 130 with a pre-tensioned membrane 140 for fabricating the next layer of the cured part 120. FIG. 1B shows that the next layer 160 is photopolymerized by a light source (not shown) below the elastic membrane. In FIG. 1C, the thin elastic membrane 140 at the bottom of the vat 130 is stretched as the build plate 110 is lifted initiating peel. The small peel angle is shown. Referring to FIG. 1D, the membrane 140 returns to normal pre-tensed position after being peeled off the recently printed layer (“current layer”) 160 and the resin 150 flows back to uniformly fill the vat 130.

This specific type of peel involves a thin and elastic membrane, which is typically 0.15-0.2 mm thick but could also have a thickness lower or greater than this range. There is another type of peel which uses a semi-rigid surface with an applied coating using a polymer such as polydimethylsiloxane (PDMS) and requires bending of the vat to concentrate forces/stresses and initiate as well as propagate peel. However, the present invention concerns itself with designs that use a thin elastic membrane. Examples of materials that the thin elastic membrane may be made from include fluorinated ethylene polypropylene (FEP), perfluoroalkoxy alkane (PFA), or another non-stick polymer that stretches when tensed by the lifting build platform causing a gradual initiation and propagation of peel and separation of the cured part from the membrane (see FIG. 1C). The current layer 160 adheres to both the previously printed part 120 and elastic membrane 140 after UV exposure based photopolymerization of the resin (see FIG. 1B). The build platform 110 is gradually raised by a motor to stretch the membrane 140 (see FIG. 1C) and separate (peel) the printed part 120 from it (see FIG. 1D).

FIG. 1C indicates angle 190, which is the peel angle. Generally, this angle is very low (around or less than 5 degrees) in industrial inverted VP 3D printers. However, this results in large peel forces due to most of the energy getting dissipated (in the form of frictional sliding) rather than being delivered to overcome the (largely vertical) adhesion bonds and forces during peel separation. Furthermore, in the industry standard peel process, the membrane is pre-tensioned and therefore the adhesive bonds between the cured layer and membrane are oriented more vertically. This causes the peel forces to increase because the bonds and the direction of peel forces are not well aligned. The present invention increases this peel angle so that the overall peel forces experienced by the part after every layer can be reduced. By increasing the peel angle, these cohesive bonds are now better vertically oriented with the peel forces. To more easily visualize this, imagine peeling a bandage applied to your arm. If you bend the lifted edge and pull straight up (˜90 deg peel angle) it is much easier to peel compared to peeling sideways (at a much lower angle) along the length of the tape.

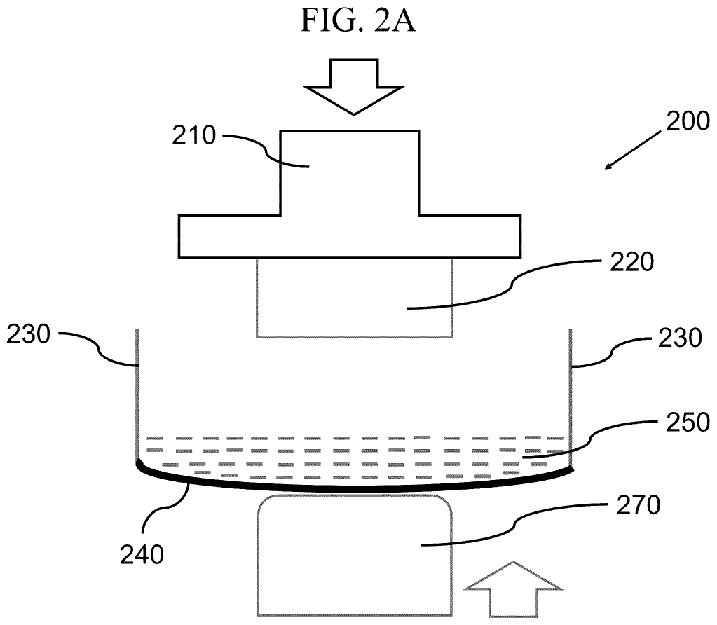

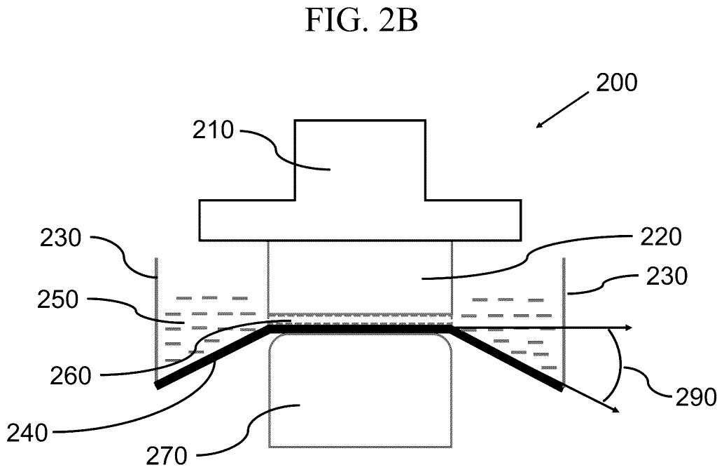

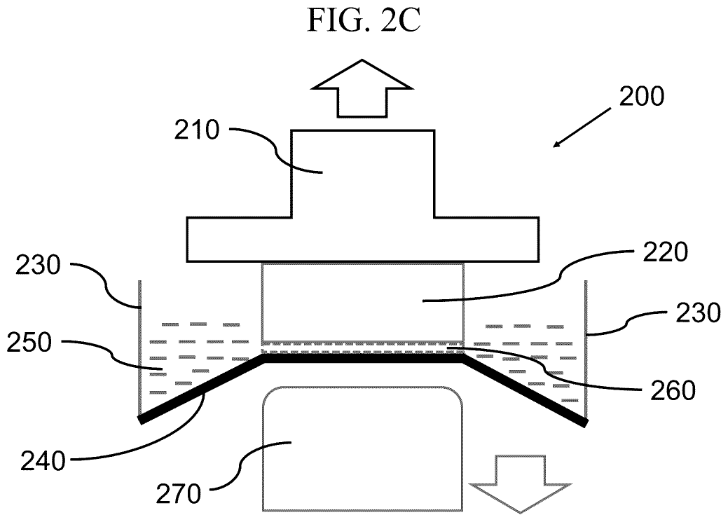

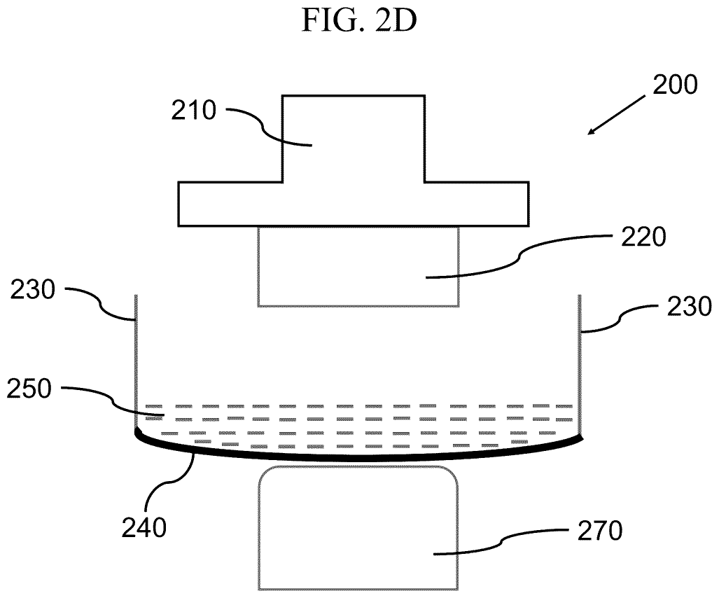

In one embodiment, the present invention increases the peel angle by lifting the flexible membrane via vertical movement of the optical unit (LCD mask, UV LEDs/UV Lasers/DLPs and associated hardware) in the upward direction, thereby pushing the loose flexible membrane at the bottom of the resin filled vat up and creating a tensed flat surface to serve as the resin curing zone (see FIGS. 2A-2D). In one embodiment, the peel angle can be higher than the industry standard peel angle. Peel angle may depend on several factors, including the cross-sectional area of the layer, the resin material, the thin elastic membrane material, the size of the vat etc. In one embodiment, the angle of the thin elastic membrane when it is peeled from the current layer is greater than about 5 degrees from the horizontal plane. In another embodiment, the angle of the thin elastic membrane when it is peeled from the current layer is greater than about 10 degrees from the horizontal plane. In one embodiment, the angle of the thin elastic membrane when it is peeled from the current layer is about 15 to about 25 degrees from the horizontal plane.

The optical unit 270 is housed below the resin filled vat, and hence the “inverted” nomenclature associated with this SLA 3D printing technology. Once the present layer 260 is cured by selective patterned UV exposure, the optical unit moves back down and the build plate 210 to which the cured layer 260 attaches is moved up to induce separation. In this embodiment, the optical unit 270 has a rounded top (shoulder) to provide a smooth and curved contacting surface for the bottom of the non-stick membrane 240. The shoulder can be a separate apparatus that is attached to the top of the optical unit 270. Alternatively, the top surface of the optical unit 270 may be shaped to have rounded corners and edges.

Referring the FIG. 2A, where like numerals refer to like features, an embodiment of the peel-based 3D printing device of the present invention 200 is shown. The device has a thin elastic membrane 240 at the bottom of a vat 230. There is resin 250 in the vat 230. A cured part 220 is attached to a build plate 210. In addition, there is an optical unit 270 located beneath the elastic membrane 240. As indicated by the arrow, the build plate 210 is lowered into the resin filled vat 230 to fabricate the next layer of the cured part 220. In addition, the optical module 270 is lifted to stretch the loose elastic membrane 240 in preparation for fabricating the next layer. FIG. 2B shows that thin elastic membrane 240 at the bottom of the vat 230 is lifted and stretched by the optical module 270 while the layer of resin 260 between the cured part 220 and the membrane 240 is photopolymerized by light from the optical module 270. The relatively larger peel angle 290, is shown.

In FIG. 2C, the thin elastic membrane 240 at the bottom of the vat 230 is stretched further to induce peel as the build plate 210 is lifted. The optical unit 270 is lowered to allow the membrane 240 to peel from the cured layer 260. Referring to FIG. 2D, the membrane 240 returns to normal loose position after being peeled off the recently printed layer and the resin 250 flows back to uniformly fill the vat 230.

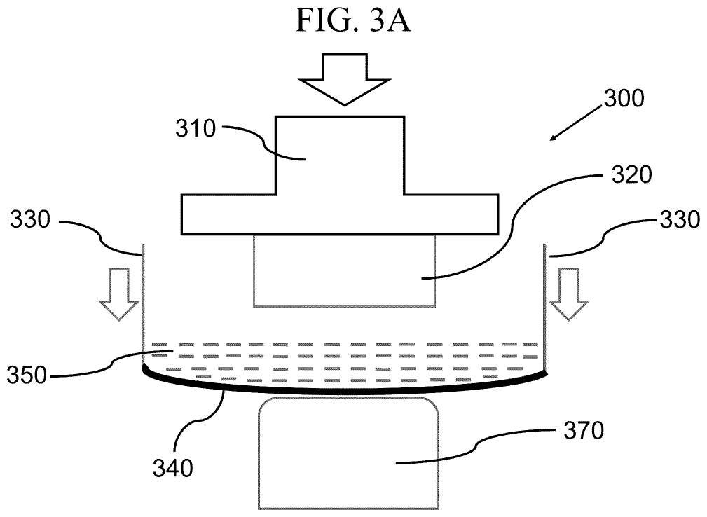

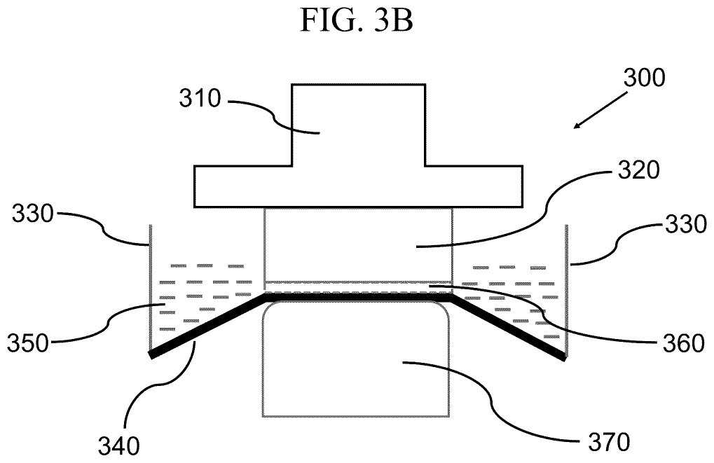

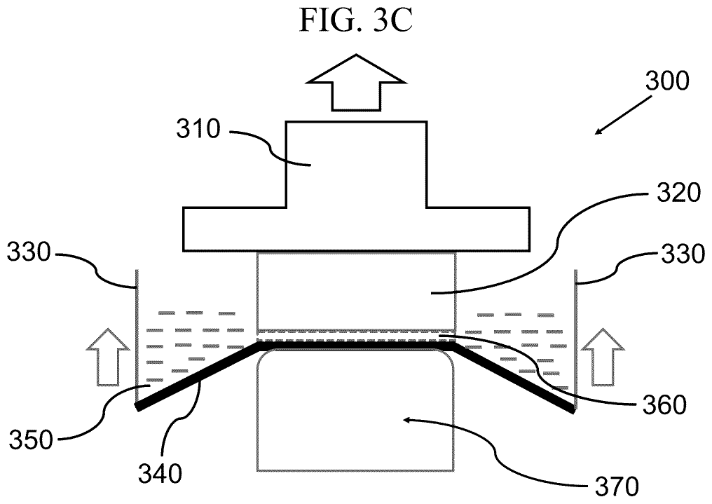

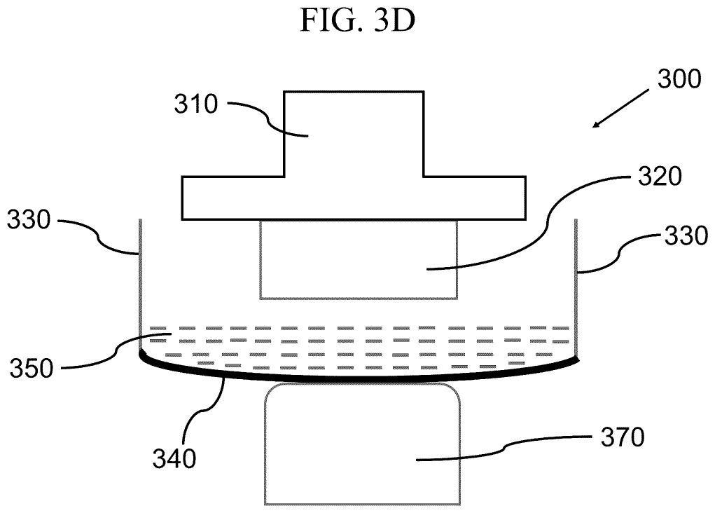

In another embodiment of the present invention, the same lift peel process can be achieved by keeping the optical unit position fixed and moving the vat vertically (see FIGS. 3A-3D). In this case, the vat 330 is lowered to stretch the non-stick membrane 340 and achieve the same effect. This approach has improved efficiency because the vat 330 is significantly less bulky than the optical module 370, and therefore it can be moved faster. Example 1 discusses this embodiment of the present invention where the vat 330 is designed to move while the optical module 370 is rigidly fixed.

Referring the FIG. 3A, where like numerals refer to like features, an embodiment of the peel-based 3D printing device of the present invention 300 is shown. The device has a thin elastic membrane 340 at the bottom of a vat 330. There is resin 350 in the vat 330. A cured part 320 is attached to a build plate 310. An optical unit 370 is located below the thin elastic membrane 340. The build plate 310 is lowered into the resin filled vat 330 and the vat 330 itself is lowered onto the optical module 370 to stretch the loose elastic membrane 340 in preparation for fabricating the next layer. In FIG. 3B, the thin elastic membrane 340 at the bottom of the vat 330 is lifted and stretched by the optical module 370 while the layer of resin 360 between the cured part 320 and the membrane 340 is photopolymerized. In FIG. 3C, the thin elastic membrane 340 at the bottom of the vat 330 is stretched further to induce peel as the build plate 310 is lifted. The vat 330 is lifted to allow the membrane 340 to peel from the cured layer 360. In FIG. 3D, the membrane 340 returns to normal loose position after being peeled off the recently printed layer and the resin 350 flows back to uniformly fill the vat 330.

### EXAMPLES

### Example 1

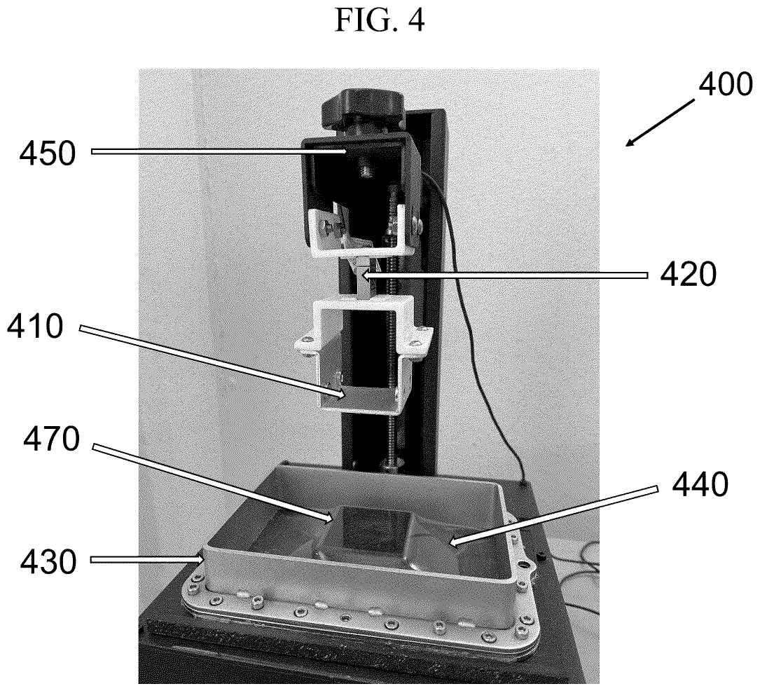

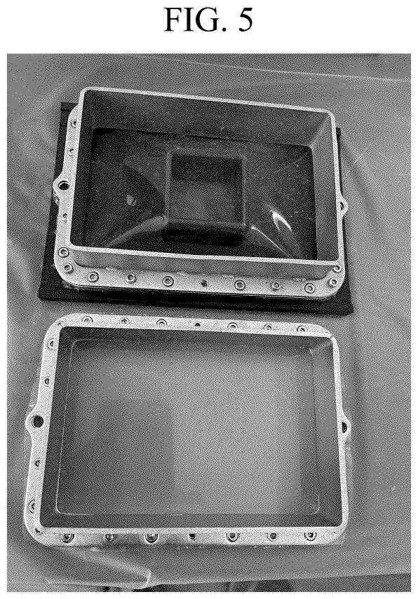

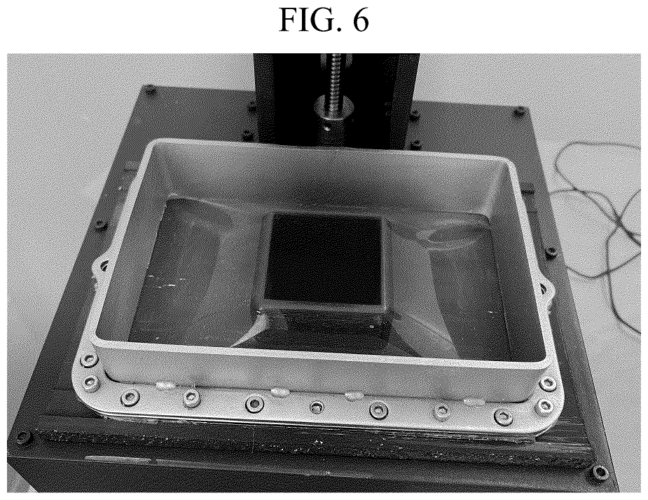

An embodiment of the novel lift-based peel design involving a moving vat was experimentally tested using the setup shown in FIG. 4. The design used a commercial desktop inverted SLA 3D printer 400 with custom design modifications as described. The setup is shown without resin in the vat for clear visibility of the stretched membrane and the custom designed shoulder. Referring to FIG. 4, elements of the printer 400 include a Z-Axis mount 450, a force sensor 420, a modified build plate 410, a vat 430, a non-stick membrane 440 and a shoulder for the optical module 470. The shoulder 470 was custom designed to stretch and lift the non-stick membrane. A comparison of the vat with and without this shoulder is shown in FIG. 5. A 40 mm×40 mm cutout was designed at the center of this shoulder to allow the UV light to pass through from the optical module at the bottom (see FIG. 6).

The vat was first lowered onto the shoulder to stretch and lift the non-stick membrane. Once the build plate was perfectly level with the top of the shoulder, a 1 mm gap was set between the bottom of the build plate and the stretched/lifted membrane atop the shoulder. Resin was poured to fill the entire vat as well as this 1 mm gap. The LED array within the optical module was turned on for a defined amount of time (2-5 min) and the masking LCD screen was disabled to allow light to transmit through. Once this 1 mm thin 40 mm×40 mm slice of resin was cured, the vat was lifted to provide clearance and the build plate was lifted by the Z-axis motor to peel the layer from the non-stick membrane. This process was repeated for each test.

### Example 2

Using the printer setup described in Example 1, a series of tests were conducted to measure peel forces. The peel forces were logged using the force sensor 420 shown in FIG. 4. However, only the peel forces after layer 3 were considered in the analysis because the initial layers always experience much higher peel forces due to the initially low fracture toughness that gradually increases as each subsequent layer is 3D printed. The data were compared against the vat with normal non-stick membrane (FIG. 5) using the same sized 40 mm×40 mm cutout customized for the standard vat without any shoulder to stretch/lift the non-stick membrane. Referring to FIG. 5, the figure shows a vat with a stretched and lifted membrane due to the black shoulder (top) in the novel lift-based peel setup, and the tensioned but straight membrane (bottom) in the industry standard peel. Referring to FIG. 6, the figure shows that with the optical module at the bottom enabled, the UV light can be seen passing through the 40 mm×40 mm cutout and the stretched/lifted non-stick membrane at the center of the shoulder.

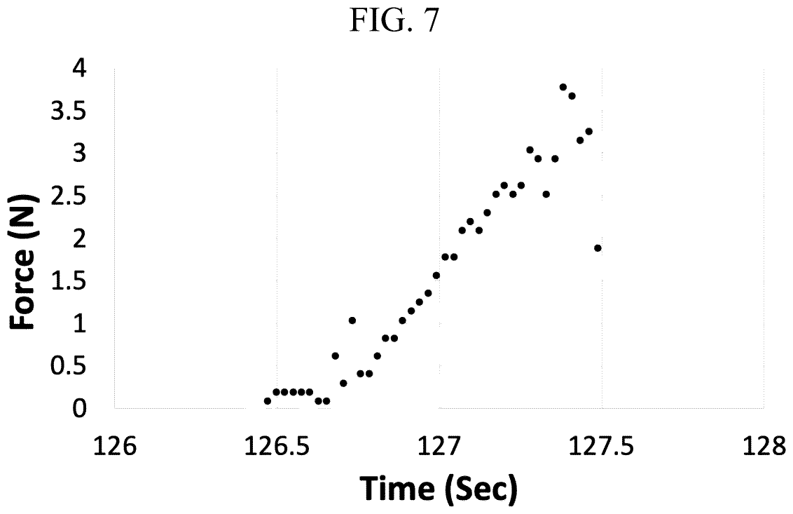

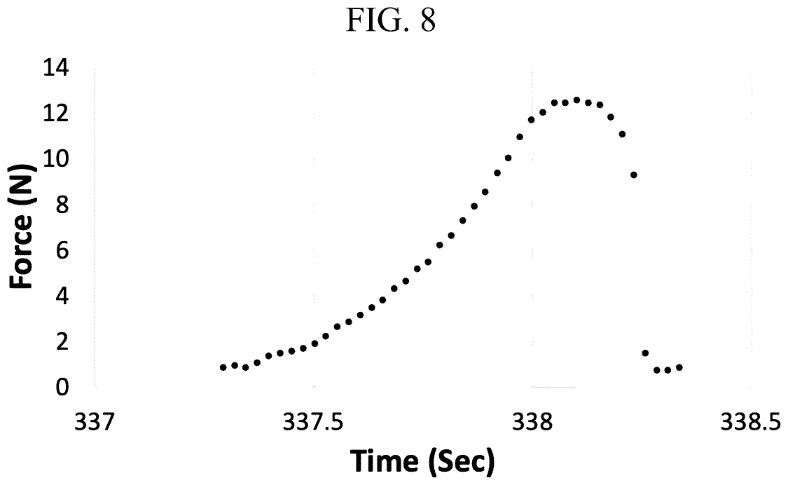

The peel force measurements are shown in the graphs of FIG. 7 and FIG. 8. Data is presented in Table 1. FIG. 7 shows a plot of the novel lift-based peel temporal force data showing a peak of 3.77N for a 40 mm width×40 mm breadth×1 mm height cuboidal layer. The units are Newtons on the Y-axis and Seconds on the X-axis. FIG. 8 shows a plot of the industry standard peel temporal force data showing a peak of 12.52N for a 40 mm width×40 mm breadth×1 mm height cuboidal layer. The units are Newtons on the Y-axis and Seconds on the X-axis.

Because of the increased peel angle (from the lifted curing zone), the peel separation forces are reduced substantially (see FIG. 7) compared to the industry standard peel (see FIG. 8). Testing shows a reduction of 63% in the peak peel forces (Table 1) even as the lift speed is 5-6× times the default speed. This would result in a ˜50-70% reduction in the overall print time (2-3× the industry standard print speed). This is a major improvement over the existing industry standard peel separation process. Furthermore, the throughput (printing speed) is expected to increase substantially because of the ability to peel at a faster rate. Additionally, materials with high adhesion or low stiffness that are otherwise not amenable to inverted VP 3D printing can likely be printed due to the huge reduction in peel forces that would otherwise damage the printed part. With such a substantial reduction in peak peel forces experienced by the part being 3D printed, it is expected that the print failure rate will also reduce. After peeling when the cured part and build platform are lowered into the resin filled vat for printing the next layer, there is a downward “squish” force created which results in deformation of the thin elastic membrane at the bottom. This compromises accuracy in the industry standard process since the vertical location is shifted compared to the desired location. The current invention addresses this challenge since by default the elastic membrane is in a “relaxed” position allowing dissipation of the “squish” forces. Subsequently, when the optical module is raised for the lift-based cure and peel (embodiment 1) or the vat is lowered (embodiment 2), the vertical location is actively controlled, and it is expected to result in significant gain in the build accuracy in that direction.

Table 1—Peak forces logged using the industry standard peel and the novel lift-based peel. A 63% reduction in the peak peel force is observed using the lift-based peel compared to the industry standard peel.

TABLE 1

| | Peak Force - Industry | Peak Force - Novel Lift- |
|---|---|---|
| Test No. | Standard Peel (N) | Based Peel (N) |
| 1 | 7.57 | 3.77 |
| 2 | 9.15 | 3.66 |
| 3 | 12.52 | 4.08 |
| 4 | 11.79 | — |
| AVG ± SD | 10.26 ± 2.3 | 3.84 ± 0.22 |

### Example 3

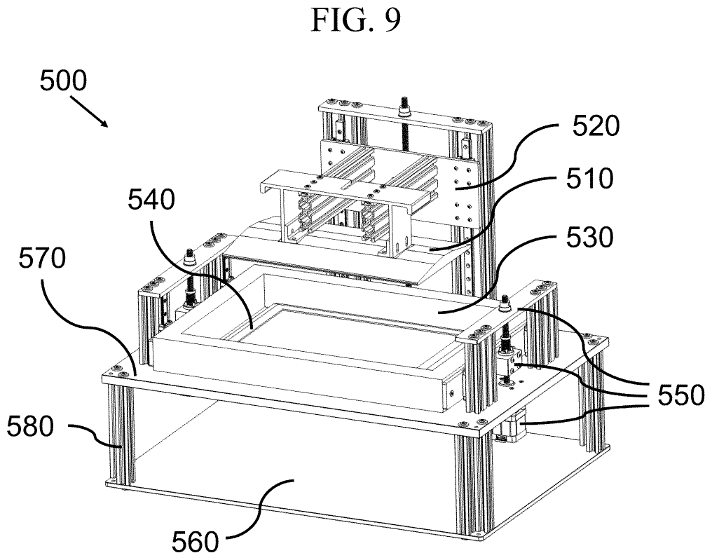

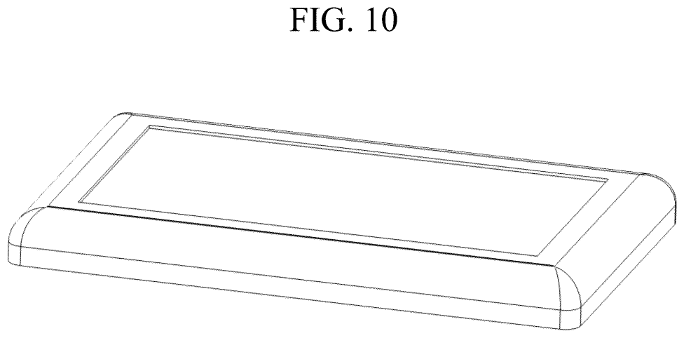

A full prototype 3D printer was designed incorporating an embodiment of the present invention with a movable vat (see FIG. 9). The design used an optical module having a shoulder with rounded corners and edges (fillets), as shown in FIG. 10 and FIG. 9 (component 540). The optical module shoulders are what the non-stick membrane stretches over as the vat is lowered.

Referring to FIG. 9, a CAD model 500 of the prototype 3D printer with the novel lift-based peel moving vat technique incorporated (without resin in the vat) is shown. Elements of the CAD model 500 include a build plate 510, a Z-axis mounting plate 520, a vat 530, a shoulder 540, vat motion mechanism components 550, a bottom plate 560, a base plate 570, and a frame structure 580.

In one embodiment, the steps for printing one layer are as follows:
a. The vat 530 is lowered using the mechanism 550 to stretch the non-stick membrane over the shoulder 540 and create a tensioned lifted surface.
b. The build plate 510 is lowered onto this lifted surface until there is a gap exactly equal to the layer thickness (˜0.025-0.1 mm).
c. The LED array is activated and the mask screen at the center of the shoulder is programmed to transmit the precise layer mask to cure resin. The LED turns off after the programmed exposure time (˜1-10 seconds) and the mask resets.
d. The vat 530 and the build plate 510 are raised together initially.
e. The vat 530 stops after moving a certain distance while the build plate continues moving until the printed layer is peeled off the non-stick membrane and remains attached to either the build plate or the previous cured layer so as to continue adding layers to the part until completion.
f. Once the build plate 510 stops moving, the vat 530 is lowered back onto the shoulder in preparation for the next layer.
g. Resin flows back to fill the space occupied by the printed part and build plate.
h. The process now repeats until all layers of the input 3D model are completed.

Referring to FIG. 10, a magnified CAD model of the shoulder is shown. This shoulder is shown in FIG. 9 as component 540.

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

What is claimed is:

1. A method of inverted stereolithography (SLA) 3D printing with a printing device wherein the device comprises:
a. a build platform;
b. a printed part;
c. a current layer;
d. a thin elastic membrane;
e. a resin filled vat, wherein the resin has a surface with a horizontal plane; and
f. an optical module comprising a rounded top;
wherein the thin elastic membrane forms at least a portion of the bottom of the resin filled vat and the optical module is located below the resin filled vat; the method comprising:
i) lifting the thin elastic membrane to an elevated position within the resin filled vat via vertical movement of the optical module, the resin filled vat, or both,
ii) allowing resin on the thin elastic membrane to cure as a current layer, said layer being attached to the printed part,
iii) peeling the thin elastic membrane from the current layer by lowering the optical module, raising the resin filled vat, or both.

2. The method of claim 1 wherein the angle of the thin elastic membrane when it is peeled from the current layer is greater than about 5 degrees from the horizontal plane.

3. The method of claim 1 wherein the angle of the thin elastic membrane when it is peeled from the current layer is greater than about 10 degrees from the horizontal plane.

4. The method of claim 1 wherein the angle of the thin elastic membrane when it is peeled from the current layer is about 15 to about 25 degrees from the horizontal plane.

5. The method of claim 1 wherein the thin elastic membrane comprises a non-stick material.

6. The method of claim 1 wherein the rounded top of the optical module is a separate structure having a top surface with rounded corners and edges that can be attached to the optical module.

7. The method of claim 1 wherein the optical module has a top surface with rounded corners and edges.

8. The method of claim 1 wherein the thin elastic membrane is lifted to an elevated position within the resin filled vat via vertical movement of the optical module.

9. The method of claim 1 wherein the thin elastic membrane is lifted to an elevated position within the resin filled vat via vertical movement of the resin filled vat.

10. An inverted stereolithography (SLA) 3D printing device wherein the device comprises:
a. a build platform;
b. a thin elastic membrane;
c. a resin filled vat, wherein the resin has a surface with a horizontal plane; and
d. an optical module comprising a rounded top;
wherein the thin elastic membrane forms at least a portion of the bottom of the resin filled vat and the optical module is located below the resin filled vat, and further, wherein the thin elastic membrane can be raised to an elevated position within the resin filled vat via vertical movement of the optical module, the resin filled vat, or both, and the thin elastic membrane can then be lowered, returning the thin elastic membrane to a non-tensioned state.

11. The printing device of claim 10 wherein the thin elastic membrane comprises a non-stick material.

12. The printing device of claim 10 wherein the rounded top of the optical module is a separate structure having a top surface with rounded corners and edges that can be attached to the optical module.

13. The printing device of claim 10 wherein the optical module has a top surface with rounded corners and edges.

14. The printing device of claim 10 wherein the thin elastic membrane can be lifted to an elevated position within the resin filled vat via vertical movement of the optical module.

15. The printing device of claim 10 wherein the thin elastic membrane can be lifted to an elevated position within the resin filled vat via vertical movement of the resin filled vat.
